(19) United States
(12) Patent Application Publication
(10) Pub. No.: US 2014/0163940 A1
(43) Pub. Date: Jun. 12, 2014

(54) METHOD AND SYSTEM FOR MODELING RF EMISSIONS OCCURRING IN A RADIO FREQUENCY BAND

(71) Applicants: DAVID E. ERISMAN, WARRENSBURG, MO (US); TROY D. CALDERWOOD, WELLSVILLE, KS (US); MARTY R. MOSIER, WOODBRIDGE, VA (US)

(72) Inventors: DAVID E. ERISMAN, WARRENSBURG, MO (US); TROY D. CALDERWOOD, WELLSVILLE, KS (US); MARTY R. MOSIER, WOODBRIDGE, VA (US)

(21) Appl. No.: 14/102,193

(22) Filed: Dec. 10, 2013

Related U.S. Application Data
(60) Provisional application No. 61/735,931, filed on Dec. 11, 2012.

(51) Int. Cl. G06F 17/50

(52) U.S. Cl. CPC G06F 17/5009
USPC 703/2; 703/13

(57) ABSTRACT

The method and system for modeling RF emissions occurring in a radio frequency band utilizes commercial off-the-shelf (COTS) hardware to perform the steps of converting legacy PDW databases to RF signal I and Q format and storing the I and Q data in a digital I and Q data signal library. Alternatively, real-time RF signals are recorded in I and Q format and routed to the library. Moreover, a synthesizer is provided to form I and Q data and forward the data to the library. I and Q library data is time-tagged. An RF editor includes editing tools to modify the I and Q library accordingly, as required. A channelizer extracts channel information from the I and Q data and sends that channelized data to at least one to vector signal generator. A combiner is used to combine outputs of multiple vector signal generators connected to the channelizer.

### CROSS-REFERENCE TO RELATED APPLICATION

This application claims the benefit of U.S. Provisional Patent Application Ser. No. 61/735,931, filed Dec. 11, 2012.

### BACKGROUND OF THE INVENTION

1. Field of the Invention

The present invention relates to Radio Frequency (RF) test and measurement systems, and particularly to a method and system for modeling RF emissions occurring in a radio frequency band.

2. Description of the Related Art

In order to fully characterize radio frequency (RF) signals, RF signal measurement has traditionally been done by different types of instruments. Oscilloscopes are used to measure RF amplitude vs. time and display the resulting sine waves on a cathode ray tube or video display, the horizontal axis displaying time and the vertical axis displaying voltage. Since the oscilloscope is not good at accurately measuring frequency, the spectrum analyzer is used to measure frequency vs. power. The horizontal axis displays frequency, while the vertical axis displays power. The spectrum analyzer can measure such parameters as signal or carrier level, sidebands, harmonics, and phase noise.

Since these instruments only measure amplitude vs. time and frequency vs. power, yet another type of test instrument is employed to provide additional insight into the characterization of RF signals and devices. An RF network analyzer combines the useful features of a spectrum analyzer with the addition of a specialized RF signal generator in order to analyze a network or RF device. The RF network analyzer can measure a variety of different parameters, including the amplitude response as well as the network scattering parameters, or S-parameters, which are the transmission and reflection coefficients for the device under test. These S-parameters contain both amplitude and phase information, and therefore a vector network analyzer is able to give a very comprehensive analysis of an RF device.

RF test equipment has evolved, and modern advances in digital electronics technology have improved the accuracy and resolution of all of the conventional types of RF test and measurement instrumentation. Additionally, advances in digital signal processing (DSP) that utilize discrete analog-to-digital samples have resulted in even more detailed RF analysis capability. DSP techniques have recently been incorporated into oscilloscopes, spectrum analyzers, and network analyzers to enhance their measurement capabilities, but only brief snapshots of the RF signal are possible with current technology due to the high sampling rate required and the resulting depth of memory required. For example, in order to satisfy Nyquist sampling requirements, at least two samples per cycle of the RF signal being analyzed must be continuously stored in memory in order to utilize DSP analysis techniques. For analyzing an RF signal with a bandwidth of 1 GHz, a sampling rate of at least 2 GS/s must be employed, which means that a snapshot capture 2 seconds in duration with 16-bit A/D resolution would require 8 GigaBytes of high speed memory capable of being written to at a rate of 4 GB per second, which requires, on average, every sample to be written to memory in less than 25 billionths of a second (25 picoseconds).

Thus, a method and system for modeling RF emissions occurring in a radio frequency band solving the aforementioned problems is desired.

### SUMMARY OF THE INVENTION

The method and system for modeling RF emissions occurring in a radio frequency band utilizes commercial off-the-shelf (COTS) hardware to perform the steps of converting legacy PDW databases to RF signal I and Q format and storing the I and Q data in a digital I and Q data signal library. Alternatively, real-time RF signals are recorded in I and Q format and routed to the library. Moreover, a synthesizer is provided to form I and Q data and forward the data to the library. I and Q library data is time-tagged. An RF editor includes editing tools to modify the I and Q library accordingly, as required. A channelizer extracts channel information from the I and Q data and sends that channelized data to at least one vector signal generator. A combiner is used to combine outputs of multiple vector signal generators connected to the channelizer.

These and other features of the present invention will become readily apparent upon further review of the following specification and drawings.

### BRIEF DESCRIPTION OF THE DRAWINGS

FIG. 1 is a block diagram of a system for modeling RF emissions occurring in a radio frequency band according to the present invention.

FIG. 2 is a block diagram illustrating the editing block of the system of FIG. 1.

FIG. 3 is a block diagram illustrating further components of the system of FIG. 1.

Similar reference characters denote corresponding features consistently throughout the attached drawings.

### DETAILED DESCRIPTION OF THE PREFERRED EMBODIMENTS

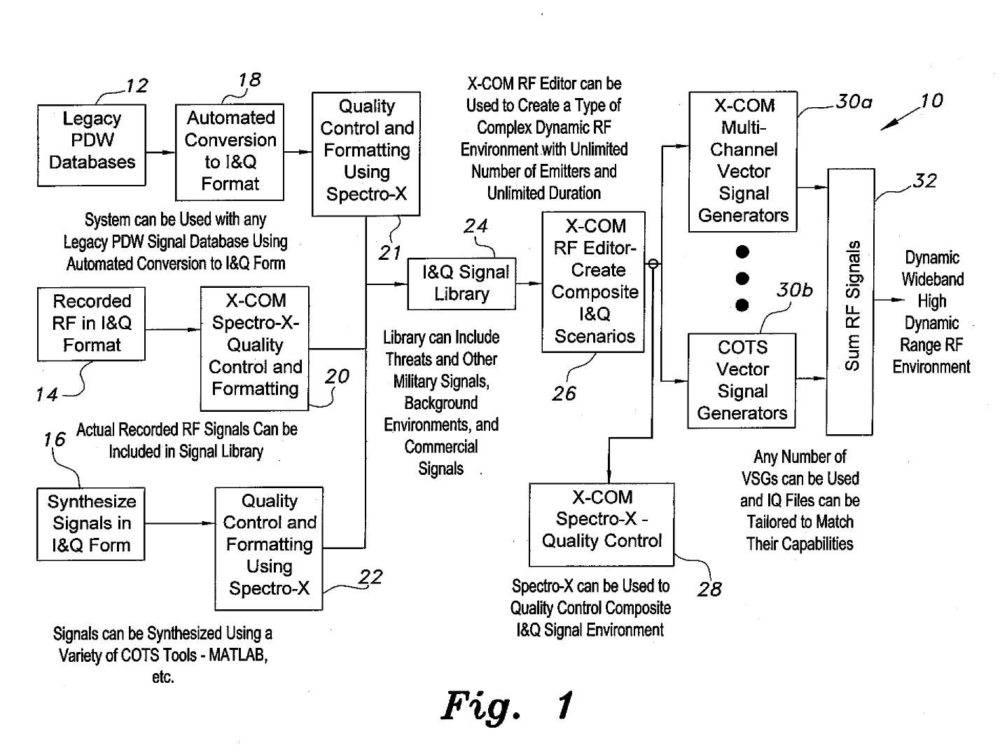

Referring to FIGS. 1-3, the method and system for modeling RF emissions occurring in a radio frequency band 10 includes instruments that use multiple high-speed digitizers 302a for digitizing RF signals, an I/Q data storage unit 302b having a special file system and memory devices for recording and storing the samples over long time periods, and digital processing equipment that includes a modify module 202, a signal combiner 204, and a channel extractor 206 for digitally processing the samples to compute and display all the information of interest, plus the ability to regenerate the samples back into RF signals again.

Both real-time and post-processing signal processing techniques are simultaneously employed to completely characterize and display the same RF signal characteristics that currently require multiple expensive and specialized test and measurement instruments to perform. Characterization of the RF signals includes representing each RF signal as its real and imaginary part and an associated time tag.

The present method and system 10 provides the functionality of an oscilloscope, a spectrum analyzer, a network analyzer, and a signal generator via the use of novel software programs running in off the shelf equipment that provides more RF analysis capability than the combined utility of separate instrumentation. The present system utilizes long-term storage of high-speed sampled digital values, playback via D/A converters, and DSP processing to provide extremely comprehensive RF analysis capability.

In order to provide long-term storage of RF data, the present digital signal recording system and method utilizes the extremely high data throughputs of individual solid state memory chips and the memory depths of individual hard drive storage units. The present method allows for long term continuous storage of the digital RF data for many minutes or hours by creating a file system that stores RF signal components and associated time tags. The time tags are provided by an external precision time source. A correlation module time-correlates the data to external triggers. Field Programmable Gate Arrays (FPGAs) are connected to a digitizer, thereby allowing continuous acceptance of every digital sample. Each datum is formatted into a packet having an optimum packet length. A unique number is assigned to each packet. The packets are routed into separate storage paths according to the assigned packet numbers. The data in each path is further directed to multiple hard drives using storage controllers or memory mapping. Entire or partial files of the packets and digital samples can be tracked and retrieved based on the associated packet number or associated time stamp.

The present method builds and uses a library of RF signals in I&Q form and provides an editor capable of mathematically manipulating these signals to combine them in ways that create very complex, arbitrarily long unique RF signals and a spectrum that can be very realistic, much more so than is possible using related art methodology. The I and Q data may be synthesized, recorded, or obtained via PDW conversion. For example, legacy PDW databases may be converted to RF signal I and Q format which is then stored in a digital I and Q data signal library. I and Q processing is based on the principle that an RF signal has a real in-phase component and an imaginary quadrature phase component, and can be represented as:

I+jQ, (1)

where I is the real part and jQ is the imaginary part of the signal. In terms of sines and cosines, the signal may be represented as:

A(t)·cos[2πft+φ(t)]=I(t)·cos(2πft)+Q(t)·(−sin(2πft)), (2)

where I(t) is the in-phase component and Q(t) is the out-of phase quadrature component. Instead of storing a direct sample of the RF signals, the library stores and time tags the I and Q components of the RF signals. Hereinafter, the I and Q components may be referred to as I&Q, I and Q, I/Q, or I and Q. The present component storage and time tagging method makes it possible to very accurately re-create very complex dynamic spectrums for testing systems and equipment that are much more likely to be able to identify these problems earlier on and better predict actual performance in the real world.

To maximize utility, the present RF emissions modeling method provides a library of signals that contains a wide variety of signal types, including background noise, many different types of emitters, signals that have been recorded, and also signals that may have been synthesized. Moreover, the present RF emissions modeling method is compatible with historical databases, such as PDW databases that have been used in the past by related art signal generators.

PDW (pulse descriptor word) databases 12 (as shown in FIG. 1) are used to specify the characteristics of radar-like signals. A PDW signal representation consists of a table of values, one row per pulse that includes the entries that very precisely define the pulse, including frequency, start time, end time, rise time, fall time, average power, peak power, pulse modulation, etc. There is a very large database of these representations, and they are commonly used with traditional signal generation equipment to define the signals to be produced. To be useful, the present method seamlessly processes these databases. Table 1 shows the Pulse Description Word that the present RF emissions modeling method is capable of converting to the In-Phase and Quadrature phase (I and Q) format.

TABLE 1
Pulse Description Word (PDW)

| Peak | Average | | | | | | |
|---|---|---|---|---|---|---|---|
| Power | Power | Start Time | | Rise Time | Fall Time | | |
| (dbm) | (dbm) | (sec) | Dur (sec) | (sec) | (sec) | PRI (sec) | Freq (Hz) |
| −22.04 | −23.97 | 0.000000327 | 0.00000002 | 0.000000005 | 0.000000005 | 0.000000053 | 25000000 |
| −20.89 | −24.03 | 0.000000353 | 0.000000033 | 0.000000005 | 0.000000005 | 0.000000027 | 0 |
| −23.56 | −25.65 | 0.000000393 | 0.000000047 | 0.000000005 | 0.000000005 | 0.00000004 | 10714285.7 |
| −21.84 | −26.33 | 0.000000453 | 0.00000008 | 0.000000005 | 0.00000001 | 0.00000006 | 18750000 |
| −26.09 | −28.32 | 0.00000054 | 0.000000027 | 0.00000001 | 0.000000008 | 0.000000087 | 0 |
| −23.02 | −26.97 | 0.000000573 | 0.000000087 | 0.000000005 | 0.000000014 | 0.000000033 | 17307692.3 |
| −24.36 | −28.32 | 0.000000667 | 0.000000067 | 0.000000005 | 0.000000006 | 0.000000093 | 0 |
| −25.6 | −28.28 | 0.00000074 | 0.000000047 | 0.000000006 | 0.000000011 | 0.000000073 | 0 |
| −24.04 | −28.89 | 0.000000793 | 0.000000087 | 0.000000005 | 0.000000005 | 0.000000053 | −5769230.8 |
| −34.73 | −34.73 | 0.000000887 | 0.000000007 | 0.000000006 | 0.000000005 | 0.000000093 | −75000000 |

The present RF emissions modeling method 10 converts the PDW tabular information into equivalent I&Q representation. This is done in software, or possibly in software with hardware-processing acceleration using FPGA or DSP capabilities. To be used downstream by the present method, the PDW database information is processed for each signal in the PDW database to create an equivalent I&Q file.

A quality control and formatting 21 is performed on the newly created I&Q file to verify that the I&Q representation accurately reproduces the PDW parameters. This quality control allows the user to inspect the signal as it would appear once converted back into RF form and to measure the signal and compare it against the various parameters in the PDW file to verify accuracy.

In addition to PDW format representations, the present RF emissions modeling method may use actual recorded RF signals. As shown in FIG. 1 at 14, the actual RF signals are captured in I and Q format. A spectrum analyzer or other receiver may be used to accomplish capture the signals in I and Q format. An Analog-to-Digital Converter may be used to convert the I and Q data to digital form. The control and formatting 20 processes the digital I and Q data initially to compensate for instrument errors. The digital I and Q data and associated time stamps, i.e., time tags, are then stored in an I and Q signal library 24. Thus, the present RF emissions modeling method may reproduce actual signals, thereby eliminating the errors that are sometimes introduced by converting to PDW format and then back to RF. The present method's actual RF signal recording method also allows the nuances of a particular signal to be accurately reproduced, which may otherwise be lost by other modeling processes.

Quality control and formatting 20, 21, 22, and 28 are common to all of the input processes that allow a visualization of the I&Q signal representation in what will be its RF form to make sure that the conversion was good and to, for example, allow a particular signal to be extracted from a longer recording if the rest of the recording is not of interest. The quality control and formatting 20, 22, and 28 helps to improve the fidelity of the RF emissions modeling method 10.

The I&Q signal library 24 represents individually all of the elements that ultimately may be used in different combinations to create the desired RF emissions test scenarios. The library database can contain hundreds or thousands of files and may be many Terabytes in size. Storage controllers allow for high-speed file transfer capability >400 MB/s. Because of the I and Q with time tag storage format, the storage capacity of the library 24 is not constrained by such considerations as, e.g., Nyquist sampling rates. Moreover, the I&Q representations contain 100% of the signal information, and thus, for example, if the recording is of a particular radio transmission, be it voice or data, when recreated and demodulated, the voice or data information can be extracted.

Software of the RF emissions modeling method 10 provides off-the-shelf mathematical formulas to combine the I&Q information stored in the library 24. The RF layout Graphical UI 200 is designed to have the look and feel of a multi-track audio signal combiner. RF layout GUI 200 accesses data from the I and Q digital library 24 and allows individual I&Q files from the library 24 to be selected, precisely aligned in time to nano-second resolution, individually manipulated by frequency shifting, bandpass filtering, applying frequency dependent weighting functions, changing amplitude and relative phase, etc., in a modify module 202. The end result of using the editor 26 and its modify module 202 is a new I&Q signal representation that is stored in the I and Q digital library 24, this time including all the signals at the desired frequencies, power levels, and other characteristics.

The spectrum being created by the system can be changed at will simply by changing the I&Q representation using the RF Editor 26. The RF Editor 26 also allows the user to create a relatively large bandwidth RF spectrum containing many signals at different frequencies and then filter it to create multiple I&Q representations, each containing only a segment of the signals. Segments can be manipulated by using the RF Editor 26 to add noise, band-limiting, and the like. Thus, the RF Editor 26 allows the I&Q files to be matched in bandwidth to the vector signal generator capabilities so that multiple vector signal generators can be combined by RF signals summing 32 to create a very broadband spectrum. Moreover, the RF Editor 26 allows the user to conduct searches of the recordings for signals of interest. Different recordings can be correlation-tested to find similarities and differences in the various recordings. The RF Editor 26 allows large datasets to be searched to easily locate and analyze signals. The RF Editor may then identify signals based on defined modulation formats. The Digital Library 24 may be configured to contain known signals, allowing the system to classify unknown recorded signals by comparing them to the known signals in the Digital Library 24. The method's classification process accepts as input user specifications, such as carrier frequency, start/stop time, confidence level %, modulation format/input reference file, and the like.

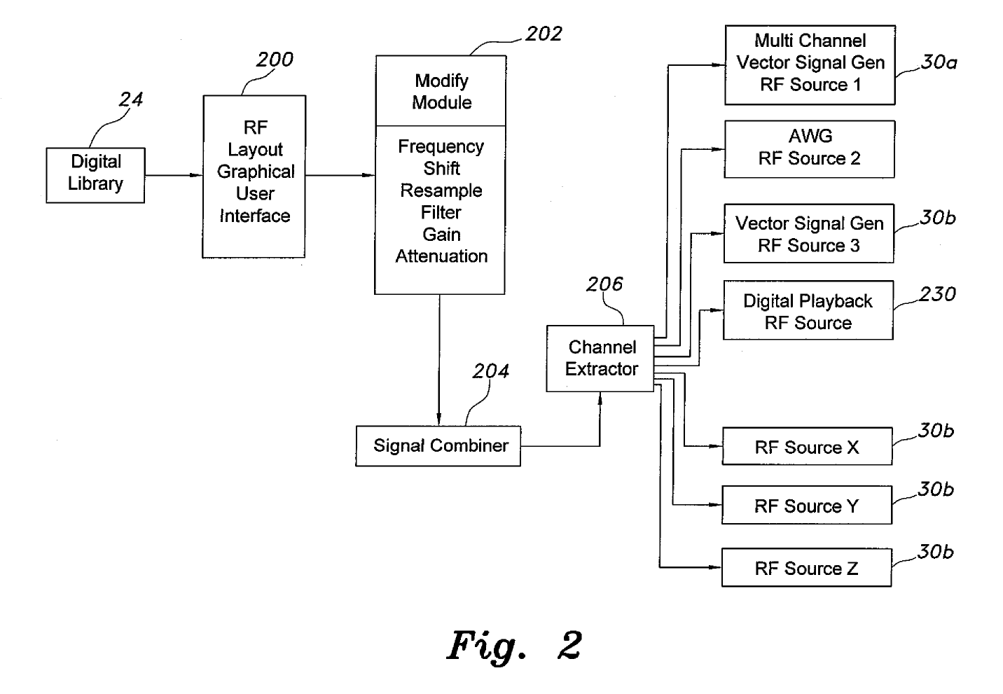

As shown in FIG. 2, the Graphical User Interface 200 will pull from the Digital Library 24 to build its output. The GUI 200 allows the user to layout the digital files in time and change the characteristics of the signal with the Modify Module 202. The Modify Module 202 allows the user to Frequency Shift, Resample, Filter, and/or Gain/Attenuate. Using the signal combiner 204, all signals are combined into a single RE representation to assess the needed RF Sources. The Channel Extractor 206 separates the digital signals for each RF Source, along with timing and control commands. These digital signals and timing and control commands are sent to each RF Source 20a, 30b, and 230 to generate the user-scripted RF output. The editor 26 may also perform DSP analysis on the RF data stored in the I and Q signal library 24.

Editing using the DSP analyzer allows extreme slow motion playback capability for creating high resolution RF images. Moreover, the software includes a Scrolling Spectrogram and FFT display with variable persistence, the software allowing for multi-window analysis displays and dual monitor capability.

As was the case for the processes of creating I&Q files for the I&Q library, Spectro-X provides a quality control step 28 after the RF Editor 26 has been used to create the I&Q files by allowing the signals to be visualized as they will appear once converted to RF. This allows for quality control and for verification that the desired characteristics have been incorporated in the file to be transmitted.

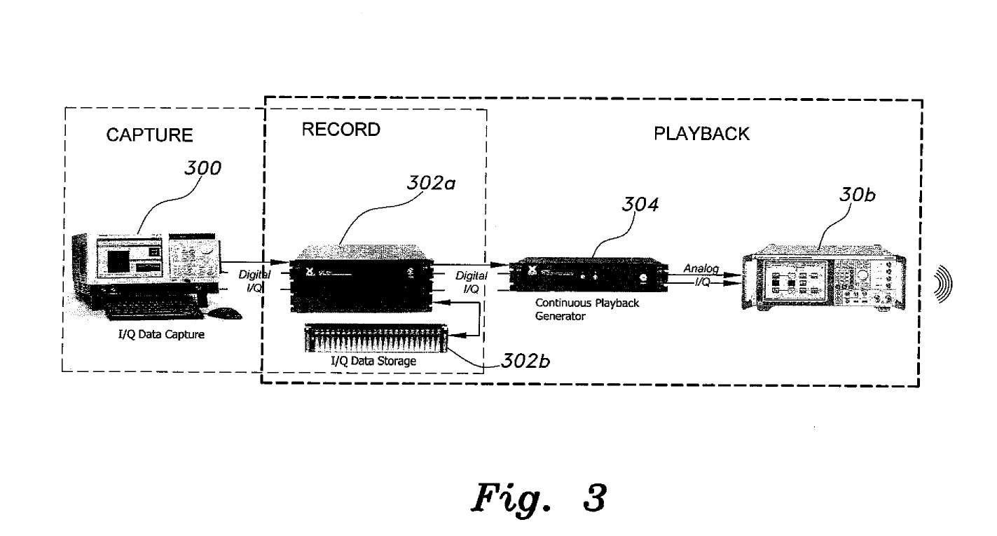

The Vector Signal Generators (VSGs), e.g., units 30a and 30b, are used to convert I and Q information into RF signals at the desired actual broadcast frequency. These devices are commercially available, i.e., commercial off-the-shelf (COTS). The present method 10 has the ability to use as many VSGs as desired, and for any frequency range needed to create spectrum that is arbitrarily broad and at any frequency from basically DC to 40 GHz or higher. As new VSGs come on the market, these can be added to the system at any time to increase its capabilities. As shown in FIG. 3, the hardware chain required to perform the RF emissions modeling method includes a Real-Time Spectrum Analyzer 300 providing digital I and Q data and an I and Q data recording system 302a, including mass I/Q storage device 302b. The recording system 302a has a digital I/Q output path to an I/Q data playback device, which is configured as a continuous playback generator and may have analog and/or I/Q data output that feeds a vector signal generator, such as unit 30b.

Depending on the application, it may be desirable to use the summation unit 32 to combine any two or more VSGs into a common RF output. This is typically done to create broader frequency ranges via a combination of the signals from several devices, each tuned to adjacent frequency bands.

Typical applications using the present RF emissions modeling method include creating complex RF environments for testing radio and radar receivers, creating complex RE environments for testing wireless systems, creating complex RF environments to test the ability of systems to deal with imperfections, noise, etc., and creating multiple test scenarios to support testing of radio, radar and similar systems.

It will be understood that the diagrams in the Figures depicting the method and system for modeling RF emissions occurring in a radio frequency band are exemplary only, and may be embodied in a dedicated electronic device having a microprocessor, microcontroller, digital signal processor, application specific integrated circuit, field programmable gate array, any combination of the aforementioned devices, or other device that combines the functionality of the method and system for modeling RF emissions occurring in a radio frequency band onto a single chip or multiple chips programmed to carry out the method steps described herein, or may be embodied in a general purpose computer having the appropriate peripherals attached thereto and software stored on a non-transitory computer readable media that can be loaded into main memory and executed by a processing unit to carry out the functionality of the inventive apparatus and steps of the method described herein.

It is to be understood that the present invention is not limited to the embodiments described above, but encompasses any and all embodiments within the scope of the following claims.

I claim:

1. A computer-implemented method for modeling RF emissions occurring in a radio frequency band, comprising the steps of:
storing in-phase and quadrature (I and Q) data associated with the RF emissions in an I and Q signal library;
accepting I and Q signal library data edit commands from a user via a GUI interface;
modifying the I and Q signal library data according to the edit commands, thereby providing modified I and Q signal library data;
storing the modified I and Q signal library data in the I and Q signal library;
combining the I and Q data including the modified I and Q signal library data into a composite RF signal modeling the RF band;
extracting channel information from the composite RF signal, thereby resulting in channelized RF signal data; and
routing the channelized RF signal data to disparate vector signal generators based on the channel information to provide real-world RF emissions based on the RF band modeling.

2. The computer-implemented method for modeling RF emissions according to claim 1, further comprising the step of combining outputs from the disparate vector signal generators.

3. The computer-implemented method for modeling RF emissions according to claim 1, wherein the I and Q modification step further comprises the step of mathematically manipulating the I and Q data to provide a complex combination that represents a unique, arbitrarily long RF signal.

4. The computer-implemented method for modeling RF emissions according to claim 1, further comprising the step of providing in said library a wide variety of signal types, including background noise, many different types of emitters, signals that have been recorded, and also signals that have been synthesized.

5. The computer-implemented method for modeling RF emissions according to claim 1, further comprising the steps of:
converting legacy PDW databases to RF signal I and Q format; and
storing a digital representation of the RF signal I and Q formatted data into the I and Q signal library.

6. The computer-implemented method for modeling RF emissions according to claim 5, further comprising the step of associating a time tag with each datum of said RF signal I and Q data.

7. The computer-implemented method for modeling RF emissions according to claim 6, wherein the step of storing a digital representation of the RF signal I and Q formatted data into the I and Q signal library further comprises the step of incorporating at least one Field Programmable Gate Array (FPGA) in combination with a digitizer to allow continuous acceptance of every digital sample onto recording media.

8. The computer-implemented method for modeling RF emissions according to claim 7, further comprising the steps of:
allowing a user to inspect the I & Q signal as it would appear once converted back into RF form; and
allowing the user to measure the I & Q signal and compare it against various parameters in the PDW databases to verify signal accuracy.

9. A computer software product, comprising a non-transitory medium readable by a processor, the non-transitory medium having stored thereon a set of instructions for modeling RF emissions occurring in a radio frequency band, the set of instructions including:
(a) a first sequence of instructions which, when executed by the processor, causes said processor to store in-phase and quadrature (I and Q) data associated with the RF emissions in an I and Q signal library;
(b) a second sequence of instructions which, when executed by the processor, causes said processor to accept I and Q signal library data edit commands from a user via a GUI interface;
(c) a third sequence of instructions which, when executed by the processor, causes said processor to modify the I and Q signal library data according to the edit commands, thereby providing modified I and Q signal library data;
(d) a fourth sequence of instructions which, when executed by the processor, causes said processor to store the modified I and Q signal library data in the I and Q signal library;
(e) a fifth sequence of instructions which, when executed by the processor, causes said processor to combine the I and Q data including the modified I and Q signal library data into a composite RF signal modeling the RF band;
(f) a sixth sequence of instructions which, when executed by the processor, causes said processor to extract channel information from the composite RF signal, thereby resulting in channelized RF signal data; and
(g) a seventh sequence of instructions which, when executed by the processor, causes said processor to route the channelized RF signal data to disparate vector signal generators based on the channel information to provide real-world RF emissions based on the RF band modeling.

10. The computer software product according to claim 9, further comprising an eighth sequence of instructions which, when executed by the processor, causes said processor to combine outputs from the disparate vector signal generators.

11. The computer software product according to claim 10, further comprising a ninth sequence of instructions which, when executed by the processor, causes said processor to mathematically manipulate the I and Q data to provide a complex combination that represents a unique, arbitrarily long RF signal.

12. The computer software product according to claim 10, further comprising a tenth sequence of instructions which, when executed by the processor, causes said processor to provide in said library a wide variety of signal types, including background noise, many different types of emitters, signals that have been recorded, and also signals that have been synthesized.

13. The computer software product according to claim 12, further comprising:
an eleventh sequence of instructions which, when executed by the processor, causes said processor to convert legacy PDW databases to RF signal I and Q format; and
a twelfth sequence of instructions which, when executed by the processor, causes said processor to store a digital representation of the RF signal I and Q formatted data into the I and Q signal library.

14. The computer software product according to claim 13, further comprising a thirteenth sequence of instructions which, when executed by the processor, causes said processor to associate a time tag with each datum of said RF signal I and Q data.

15. The computer software product according to claim 14, further comprising a fourteenth sequence of instructions which, when executed by the processor, causes said processor to, during storage of the RF signal I and Q formatted data into the I and Q signal library, incorporate at least one Field Programmable Gate Arrays (FPGA) in combination with a digitizer to allow continuous acceptance of every digital sample on to recording media.

16. The computer software product according to claim 15, further comprising:
a fifteenth sequence of instructions which, when executed by the processor, causes said processor to allow a user to inspect the I & Q signal as it would appear once converted back into RF form; and
a sixteenth sequence of instructions which, when executed by the processor, causes said processor to allow the user to measure the I & Q signal and compare it against various parameters in the PDW databases to verify signal accuracy.

17. An RE emissions modeling system, comprising:
means for storing in-phase and quadrature (I and Q) data associated with the RE emissions in an I and Q signal library;
means for accepting I and Q signal library data edit commands from a user via a GUI interface;
means for modifying the I and Q signal library data according to the edit commands, thereby providing modified I and Q signal library data;
means for storing the modified I and Q signal library data in the I and Q signal library;
means for combining the I and Q data including the modified I and Q signal library data into a composite RF signal modeling the RF band;
means for extracting channel information from the composite RF signal, thereby resulting in channelized RF signal data; and
means for routing the channelized RF signal data to disparate vector signal generators based on the channel information to provide real-world RF emissions based on the RF band modeling.

18. The computer-implemented method for modeling RF emissions according to claim 17, further comprising:
means for combining outputs from the disparate vector signal generators; and
said means for modifying the I and Q signal library data further comprises means for mathematically manipulating the I and Q data to provide a complex combination that represents a unique, arbitrarily long RE signal.

19. The computer-implemented method for modeling RF emissions according to claim 18, further comprising:
means for providing in said library a wide variety of signal types, including background noise, many different types of emitters, signals that have been recorded, and also signals that have been synthesized;
means for converting legacy PDW databases to RF signal I and Q format; and
means for storing a digital representation of the RF signal I and Q formatted data into the I and Q signal library.

20. The computer-implemented method for modeling RF emissions according to claim 19, further comprising means for associating a time tag with each datum of said RF signal I and Q data, said means for storing a digital representation of the RF signal I and Q formatted data into the I and Q signal library further comprising means for incorporating at least one Field Programmable Gate Arrays (FPGA) in combination with a digitizer to allow continuous acceptance of every digital sample on to recording media.
